(19) United States
(12) Patent Application Publication
(10) Pub. No.: US 2006/0100354 A1
(43) Pub. Date: May 11, 2006

(54) Method for distributing elastomers

(76) Inventor: Anthony P. Manzara, Lake Elmo, MN (US)

Correspondence Address: 3M INNOVATIVE PROPERTIES COMPANY, PO BOX 33427, ST. PAUL, MN, 55133-3427, US

(21) Appl. No.: 10/982,427

(22) Filed: Nov. 5, 2004

(51) Int. Cl. C08L 27/12

(52) U.S. Cl. 524/544

(57) ABSTRACT

A method for distributing elastomer comprising, in order, the steps of: (a) providing a container; (b) providing elastomer; (c) inserting the elastomer into the container until the container contains about 35 percent by volume or less of elastomer and releasably sealing the container, wherein the container is adapted for insertion of a working fluid; and (d) conveying the elastomer in the partially-filled container to another entity. Typically, the method will further comprise, in order, the steps of: (e) inserting a working fluid into the container to yield a liquid elastomer composition; and (f) removing at least a portion of the liquid elastomer composition from the container.

### FIELD

The present invention relates to a method for distributing elastomers.

### BACKGROUND

Elastomers are often used in dissolved form, e.g., to be mixed with other components, processed, etc. to produce a subsequent or final product. However, elastomers are typically not shipped to users in already dissolved form because of the added expense incurred for shipping solvent weight, and more stringent packaging and handling requirements for shipping liquid materials. In addition, the shelf life of a solution may be too short to meet the time needed for manufacturer, distributor, and customer inventory needs. Also, varying customer specification requirements for concentration and solvent selection may make it more difficult for manufacturers and distributors to provide the desired range of embodiments without maintaining prohibitively large inventories.

Accordingly, elastomers are typically shipped and sold in dry form, e.g., sheets, strips, pellets, etc. Customers who use the elastomer in solution must then dissolve it, typically by placing the dry elastomer into a vessel with a suitable solvent and dissolving it to form a liquid composition that is in then used in a subsequent process, e.g., mixing with other components, to yield a final product.

Placing the dry elastomer into a vessel is often a labor intensive process. For example, the elastomer must typically be reduced to smaller size to permit insertion into the vessel and to facilitate solvation. For example, elastomer supplied in strip, chunk, sheet, or brick form may be ground up, cut into small strips, ground into smaller pellets, etc. in order to be placed in the vessel. Many of these operations are carried out by hand, adding to the expense. If the elastomer is of such a nature as to cold flow at shipping or storage temperature, the pieces are typically either treated with a partition agent such as talc or the like, or the individual pieces of elastomer are wrapped in a material which prevents the pieces of elastomer from flowing together. This last technique is preferred if the application will not tolerate the presence of a particulate partition agent. In such instances, however, the wrapping material must be separated from the elastomer and disposed of or returned for reuse.

A need exists for a more effective manner if distributing elastomer from elastomer manufacturers to elastomer users.

### DESCRIPTION

The present invention provides an improved manner of distributing elastomers. The present invention makes it more convenient and more economical to procure elastomer materials, ship them to a desired location, and use them, e.g., in a manufacturing process.

In brief summary, in one embodiment the method of the invention for distributing elastomer comprises, in order, the steps of:
a) providing a container;
b) providing elastomer;
c) inserting the elastomer into the container until the container contains about 35 percent by volume or less of elastomer and releasably sealing the container, wherein the container is adapted for insertion of a working fluid; and
d) conveying the elastomer in the partially-filled container to another entity. Typically, the method will further comprise, in order, the steps of:
e) inserting a working fluid into the container to yield a liquid elastomer composition; and
f) removing at least a portion of the liquid elastomer composition from the container.

As used herein, the term “distributing” is not limited to the business practice of purchasing quantities of product from one or more manufacturers and conveying them to retail sellers or customers. It also includes manufacturers who manufacturer elastomers and then package and convey them to other parties as described herein.

As used herein, “conveying” means to transfer the elastomer in the partially-filled container via any transaction including a sale, lease, bailment, lending, or toll manufacturing agreement from one entity to another entity.

As used herein, “entity” refers to an individual person, business enterprise including but not limited to a partnership or corporation, government unit, trust, charitable organization, etc.

The container, which is preferably releasably sealable, should be suitable for shipping elastomer. In other words, it should constructed of material(s) and have suitable configuration to contain elastomer during shipping and handling, protecting the elastomer from contamination from or exposure to outside elements while being or a size and configuration suitable for handling. For instance, it is preferably of a size that is convenient for handling, preferably has handles or rigging point to permit it to be moved about and secured in location, etc.

The container should be adapted for insertion of elastomer therein, sealing, and subsequent insertion of a working fluid therein.

In addition, the container should be suitable for storing and dissolving the elastomer, i.e., it should be compatible for use with the elastomer and suitable working fluid(s) or solvent(s), and it should contain sufficient volume to permit addition of sufficient solvent to the dry elastomer to dissolve the elastomer to a desired concentration.

Illustrative examples of containers that are suitable for embodiments of the invention include cans, barrels, totes, etc. which may be made from suitable metal, glass, plastic, or other material. In some embodiments, the container might be a flexible sealable plastic pail or drum liner with the appropriate volume to hold the elastomer and solvent but which is itself placed in another more structurally robust container or holder while the elastomer is dissolved by the solvent. For example, the flexible container might be flexible and lightweight to facilitate shipping and handling but be placed in mechanically stronger outer container during solvation to permit shaking, rolling, etc. to dissolve the elastomer.

A multitude of elastomers may be used with the present invention. Selection of the elastomer is dependent in large part upon the desired used use. For example, a number of fluoroelastomers that are used for pyrotechnic products (i.e., products that burn to generate gases, heat, light, or noise effects) or for explosive products (i.e., products that detonate to yield blast effects) could be used in the present invention. In addition, the elastomer should be soluble in a solvent or blend of solvents and capable of being dried or condensed form.

Illustrative examples of elastomers that can be transferred in accordance with the invention include fluoroelastomer copolymers of vinylidene fluoride and hexafluoropropylene, e.g., often having a fluorine content in the range of about 63 to 71 weight percent in some embodiments, polymers incorporating any of the monomers chlorotrifluoroethylene, vinylidene fluoride, hexafluoropropylene, tetrafluoroethylene, perfluorinated vinyl ethers, fluorinated cure site monomers, ethylene, substituted ethylene, or acrylate/substituted acrylate esters.

The elastomer can be inserted into the container by a number of manners as desired. Large pieces, e.g., in block or sheet form, might be ground or cut into smaller pieces and then placed inside the container. In some embodiments, the elastomer may be in the form of a liquid solution or dispersion which is placed inside the container and then dried to substantially solid form. Typically, the elastomer will be substantially dry when it is inserted into the container and when it is conveyed in accordance with the present invention. However, in some embodiments it might contain trace or small amounts of solvent.

Elastomer is placed in the container until it reaches a desired proportion of the available volume. Typically, the container will contain about 35 percent or less of elastomer, in some embodiments about 25 percent or less, and in some other embodiments about 15 percent or less. All amounts are in percent by volume. In some embodiments, the container will be charged with sufficient elastomer that the remaining volume is substantially only large enough to accommodate the desired solvent(s) loading. In other embodiments if desired, the container be larger than the volume required for the elastomer and solvent. In preferred embodiments, the container will permit dissolving of the elastomer to the desired end concentration of elastomer. For example, in many pyrotechnic manufacturing applications a concentration of about 30 weight percent fluoroelastomer in acetone is desired. This is equivalent to volume percent of about 15.75% (acetone has density of 0.79, fluoroelastomer 1.81). Thus the quantity of elastomer to be placed in the container will depend in part upon the solvent to be used and desired final concentration.

The container is then releasably sealed, e.g., by inserting plug enclosures into opening, installing screw caps on threaded opening ports, etc. The manner of releasably sealing the container will depend in substantial part upon the nature and configuration of the container. For example, 55 gallon drums which may be used in accordance with the present invention typically have 2 or 3 openings, each about ¾ inch to 2 inches in diameter, which can be releasably sealed with screw caps.

Once sealed, the container may be sold, relocated, e.g., from one manufacturing facility to another, typically involving one or more sales from one enterprise to another, with the elastomer safely contained within the container, free from contamination from outside sources and safely secured to prevent undesirable loss into the environment.

When it is desired to remove elastomer from the container, the releasably sealed container is opened sufficiently to permit insertion of one or more working fluids or solvents therein. The working fluid is chosen dependent in large part upon the elastomer, with a working fluid that is capable of solvating the elastomer being chosen. Preferably the working fluid is readily accessible, safe to work with, and compatible with the subsequent uses of the elastomer. The working fluid is chosen so as to readily dissolve the elastomer to desired concentrations, e.g., often 5 to 40% by weight but other concentrations as desired. Illustrative examples of working fluids useful herein include but are not limited to acetone, methyl ethyl ketone, other low-boiling ketones, ethyl acetate or other low-boiling esters, and combinations of low boiling ketone or ester with other solvents to modify the drying qualities or the properties of the finished film or article. In many embodiments, the working fluid preferably has a boiling point of less than about 150° C. to permit facile evaporation during later processing. In some embodiments, combinations of one or more working fluids, e.g., a blend or azeotrope, may be used as desired.

In many embodiments, the container may be spun or rolled, or agitated in some fashion to facilitate solvation of the elastomer. For example, in the case of a 55 gallon drum, it may be simply placed on a roll mill and rotated after insertion of the working fluid therein.

Within the scope of this invention it is envisioned that the elastomer supplier could provide a certified weight of the elastomer content of each container, that the containers could be recycled from the end user to the vendor for refilling, that the flexible inner containers (if employed) could be discarded and the outer rigid containers be reused, that dense objects could be placed in the containers to increase the rate of solution by causing turbulence or breaking up agglomerated elastomer pieces, that the containers may include baffles or be fitted with an agitator, and that the temperature of the operations may be controlled to improve the results.

Further details of the invention are defined in the features of the claims.

Various modifications and alterations of this invention will become apparent to those skilled in the art without departing from the scope and spirit of this invention.

What is claimed is:

1. A method of distributing elastomer comprising, in order, the following steps: providing a container;
inserting elastomer into said container until said container contains about 35 percent by volume or less of said elastomer and releasably sealing said container, wherein said container is adapted for insertion of a working fluid; and
conveying said elastomer to another entity.

2. The method of claim 1 further comprising, in order, the following steps:
inserting a working fluid into said container to yield a liquid elastomer composition; and
removing at least a portion of said liquid elastomer composition from said container.

3. The method of claim 1 wherein said elastomer is in substantially solid form when it is inserted into said container.

4. The method of claim 1 wherein said elastomer is a fluoroelastomer.

5. The method of claim 4 wherein said fluoroelastomer comprises vinylidene fluoride as a co-monomer.

6. The method of claim 5 wherein said fluoroelastomer is a soluble copolymer of vinylidene fluoride and hexafluoropropylene.

7. The method of claim 6 further comprising using said fluoroelastomer as a binder in a pyrotechnic composition.

8. The method of claim 6 further comprising using said fluoroelastomer as a binder in an explosive composition.

9. The method of claim 1 further comprising releasably sealing said container after said fluoroelastomer is inserted therein.

10. The method of claim 1 wherein said elastomer is inserted into said container until said container contains about 25 percent by volume or less of said elastomer.

11. The method of claim 1 wherein said elastomer is inserted into said container until said container contains about 15 percent by volume or less of said elastomer.
